(19) United States
(12) Patent Application Publication
(10) Pub. No.: US 2019/0197938 A1
(43) Pub. Date: Jun. 27, 2019

(54) LIQUID CRYSTAL DISPLAY APPARATUS

(71) Applicant: JVC KENWOOD Corporation, Yokohama-shi (JP)

(72) Inventor: Takayuki IWASA, Yokohama-shi (JP)

(73) Assignee: JVC KENWOOD Corporation

(21) Appl. No.: 16/289,431

(22) Filed: Feb. 28, 2019

Related U.S. Application Data
(63) Continuation of application No. PCT/JP2017/007313, filed on Feb. 27, 2017.

(30) Foreign Application Priority Data
Aug. 31, 2016 (JP) 2016-168951

(51) Int. Cl. G09G 3/20; G09G 3/36; G02F 1/1362; G02F 1/1343; G02F 1/1335

(52) U.S. Cl. CPC G09G 3/2022; G09G 3/36; G02F 1/136277; G02F 2203/30; G02F 1/133553; G09G 2320/0204; G02F 2203/02; G02F 1/13439

(57) ABSTRACT

A liquid crystal display apparatus according to one embodiment includes: a plurality of pixels configured to display an image of a tone level obtained by combining a plurality of items of one-bit subframe data per frame, and provided in a matrix pattern; n latch circuits configured to supply the subframe data to each of n pixels in a row selected as a data write target among the plurality of pixels; and a timing adjustment circuit configured to adjust a timing of supply of each of the subframe data from the n latch circuits to the n pixels.

### CROSS REFERENCE TO RELATED APPLICATION

This application is a Continuation of International Application No. PCT/JP2017/007313 filed on Feb. 27, 2017, which is based upon and claims the benefit of priority from Japanese Patent Application No. 2016-168951, filed on Aug. 31, 2016, the disclosure of which is incorporated herein in its entirety by reference.

### BACKGROUND

The present invention relates to a liquid crystal display apparatus and, more particularly, relates to, for example, a liquid crystal display apparatus which is suitable to suppress an IR drop.

As one of halftone display methods of liquid crystal display apparatuses, a subframe driving method is known. The subframe driving method which is one type of a time axis modulation method divides a predetermined period (e.g., one frame which is a display unit of one image in a case of a moving image) into a plurality of subframes, and drives pixels based on a combination of subframes matching a tone which needs to be displayed. The tone to be displayed is determined according to a rate of a pixel driving period which occupies in the predetermined period, and this rate is specified based on the combination of the subframes.

In some liquid crystal display apparatuses which employ the subframe driving method, each pixel includes a master latch and a slave latch, a liquid crystal display element, and a plurality of switching transistors.

In this pixel, when one-bit first data is applied to an input terminal of the master latch via a first switching transistor and a row selection signal to be applied via a row scan line activates, the first switching transistor enters an on state, and the first data is written in the master latch.

When writing data in the master latches provided in all pixels is finished, second switching transistors provided in all pixels enter an on state in this subframe period. Thus, data of the master latches provided in all pixels is read all at once and written in the slave latches, and the data written in the slave latches is applied to pixel electrodes of the liquid crystal display elements. The same processing is performed on all pixels in each subframe period. As a result, each pixel can display a desired tone based on a combination of a plurality of subframes which compose one frame.

In addition, periods of a plurality of subframes which compose one frame are respectively allocated to the same or different predetermined periods in advance. When, for example, performing maximum tone display (displaying white), each pixel performs display in all of a plurality of subframes which compose one frame. When performing minimum tone display (displaying black), each pixel does not perform display in all of a plurality of subframes which compose one frame. When performing other tone display, each pixel selects a subframe which is displayed according to a tone to be displayed. A liquid crystal display apparatus which employs this conventional method receives digital data indicating a tone as input data, and employs a digital driving method of a two-stage latch configuration (see, for example, Japanese Patent No. 5733154).

### SUMMARY

In the liquid crystal display apparatus disclosed in Japanese Patent No. 5733154, n items of subframe data for the n pixels in the row selected as a data write target is outputted in parallel and all at once to n column data lines provided in association with the n pixels. In this case, although a sufficient function is normally exhibited, when the number of column data lines increases as the number of pixels increases, a current flows in parallel and all at once to these column data lines. Therefore, the current flowing from a power supply voltage terminal to a ground voltage terminal instantaneously becomes high (i.e., a peak consumption current becomes high). Hence, there is a problem that an IR drop phenomenon that a power supply voltage VDD lowers or a ground voltage GND rises occurs. As a result, the liquid crystal display apparatus disclosed in Japanese Patent No. 5733154 is likely to cause, for example, an erroneous operation and image quality deterioration.

A liquid crystal display apparatus according to one aspect of the present embodiment includes: a plurality of pixels configured to display an image of a tone level obtained by combining a plurality of items of one-bit subframe data per frame, and provided in a matrix pattern; n latch circuits configured to supply the subframe data to each of n pixels in a row selected as a data write target among the plurality of pixels; and a timing adjustment circuit configured to adjust a timing of supply of each of the subframe data from the n latch circuits to the n pixels, in which the timing adjustment circuit includes a plurality of inverters, and differs a timing of supply of subframe data to an associated pixel from a first latch circuit group that is a first part of the n latch circuits from a timing of supply of subframe data to an associated pixel from a second latch circuit group that is a second part of the n latch circuits by using delays of the plurality of inverters so that these timings are delayed in two different row directions.

### BRIEF DESCRIPTION OF THE DRAWINGS

FIG. 1 is a block diagram illustrating a liquid crystal display apparatus according to a first embodiment;

FIG. 2 is a circuit diagram illustrating a specific configuration of a pixel provided to the liquid crystal display apparatus illustrated in FIG. 1;

FIG. 3 is a circuit diagram illustrating a specific configuration of an inverter which constitutes a first data holding unit provided to the pixel illustrated in FIG. 2;

FIG. 4 is a schematic cross-sectional view of the pixel illustrated in FIG. 2;

FIG. 5 is a timing chart illustrating an operation of a liquid crystal display apparatus illustrated in FIG. 1;

FIG. 6 is a view illustrating a relationship between a liquid crystal application voltage (RMS voltage) and a liquid crystal grayscale value;

FIG. 7 is a circuit diagram illustrating a specific configuration of a latch unit provided to a liquid crystal display apparatus according to an idea which does not yet arrive at the first embodiment;

FIG. 8 is a circuit diagram illustrating a specific configuration example of the latch unit provided to the liquid crystal display apparatus illustrated in FIG. 1; and

FIG. 9 is a timing chart illustrating an operation of the latch unit provided to the liquid crystal display apparatus illustrated in FIG. 1.

### DETAILED DESCRIPTION

### First Embodiment

An exemplary embodiment will be described below with reference to the drawings.

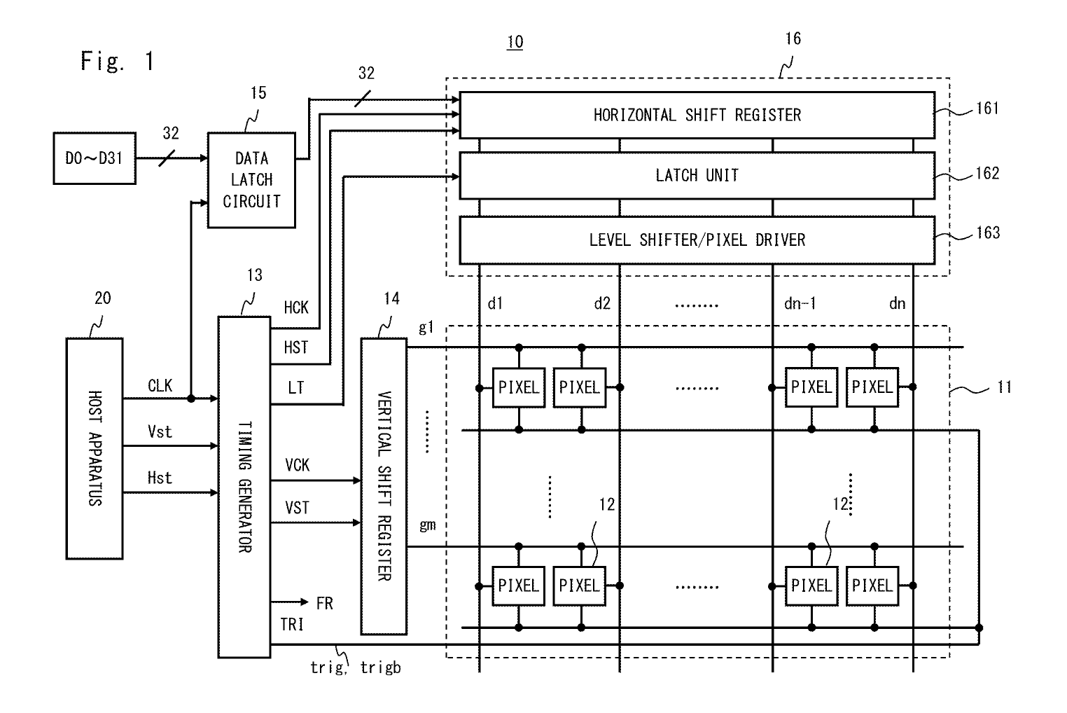

FIG. 1 is a block diagram illustrating a liquid crystal display apparatus 10 according to the first embodiment.

As illustrated in FIG. 1, the liquid crystal display apparatus 10 includes an image display unit 11, a timing generator 13, a vertical shift register 14, a data latch circuit 15 and a horizontal driver 16. The horizontal driver 16 includes a horizontal shift register 161, a latch unit 162 and a level shifter/pixel driver 163.

The image display unit 11 includes a plurality of pixels 12 which are regularly disposed. A plurality of pixels 12 are formed by disposing m (m is a natural number equal to or more than two) row scan lines g1 to gm whose one ends are connected to the vertical shift register 14 and which extend in a row direction (X direction), and n (n is a natural number equal to or more than two) column data lines d1 to do whose one ends are connected to the level shifter/pixel driver 163 and which extend in a column direction (Y direction) in a two-dimensional matrix pattern at a plurality of intersecting portions which intersect each other. All the pixels 12 in the image display unit 11 are commonly connected to trigger lines trig and trigb whose one ends are connected to the timing generator 13.

In addition, a forward trigger pulse TRI transmitted by the forward trigger pulse trigger line trig, and an inverted trigger pulse TRIB transmitted by the inverted trigger pulse trigger line trigb have a relationship (complementary relationship) of a reverse logical value at all times.

The timing generator 13 receives external signals such as a vertical synchronization signal Vst, a horizontal synchronization signal Hst and a basic clock CLK as input signals outputted from a host apparatus, and generates various internal signals such as alternating signal FR, a V start pulse VST, an H start pulse HST, clock signals VCK and HCK, a latch pulse LT and the trigger pulses TRI and TRIB based on these external signals.

The alternating signal FR is a signal which inverts the polarity per subframe, and is supplied as a common electrode voltage Vcom described below to a common electrode of liquid crystal display elements in the pixels 12 which constitute the image display unit 11.

The start pulse VST is a pulse signal which is outputted at a start timing of each subframe described below, and this start pulse VST controls switching of subframes.

The start pulse HST is a pulse signal outputted to the horizontal shift register 161 at a start timing of the horizontal shift register 161.

The clock signal VCK is a shift clock which defines one horizontal scan period (1H) in the vertical shift register 14, and the vertical shift register 14 performs a shifting operation at a timing of the clock signal VCK.

The clock signal HCK is a shift clock of the horizontal shift register 161, and is a signal for shifting data at a 32-bit width.

The latch pulse LT is a pulse signal which is outputted at a timing at which the horizontal shift register 161 finishes shifting data corresponding to the number of pixels of one row in a horizontal direction.

The forward trigger pulse TRI and the inverted trigger pulse TRIB are pulse signals which are supplied to all the pixels 12 in the image display unit 11 via the trigger lines trig and trigb, respectively.

In addition, the forward trigger pulse TRI and the inverted trigger pulse TRIB are outputted from the timing generator 13 after data is written in first data holding units in all the pixels 12 in the image display unit 11 in a certain subframe period. Thus, in this subframe period, data held by the first data holding units in all the pixels 12 in the image display unit 11 is transferred all at once to second data holding units in the associated pixels 12.

The vertical shift register 14 transfers the V start pulse VST supplied at the start timing of each subframe according to the clock signal VCK, and sequentially supplies exclusively a row scan line to the row scan lines g1 to gm in a 1H unit. Thus, the row scan lines are sequentially selected one by one in the 1H unit from the row scan line g1 at the top of the image display unit 11 to the row scan line gm at the bottom.

The data latch circuit 15 latches data of the 32-bit width in one subframe unit supplied from an unillustrated external circuit based on the basic clock CLK from a host apparatus 20, and then outputs the data to the horizontal shift register 161 in synchronization with the basic clock CLK.

In addition, the liquid crystal display apparatus 10 divides one frame of a video signal into a plurality of subframes having shorter display periods than one frame period of this video signal, and displays a tone based on a combination of these subframes. Hence, the above external circuit converts tone data indicating the tone of each pixel into a plurality of items of one-bit subframe data corresponding to a plurality of subframes. Furthermore, the above external circuit collectively supplies subframe data associated with 32 pixels belonging to the same subframe as the data of the 32-bit width to the data latch circuit 15.

When the horizontal shift register 161 is a processing system of one-bit serial data, the horizontal shift register 161 starts shifting according to the start pulse HST supplied at an initial stage of the 1H from the timing generator 13, and shifts the data of the 32-bit width supplied from the data latch circuit 15 in synchronization with the clock signal HCK.

When the horizontal shift register 161 finishes shifting data corresponding to the same number of n bits as the number of pixels n of one row of the image display unit 11, the latch unit 162 latches the data corresponding to the n bits (i.e., subframe data associated with the n pixels) supplied in parallel from the horizontal shift register 161 in synchronization with the latch pulse LT supplied from the timing generator 13, and outputs the data to the level shifter of the level shifter/pixel driver 163. In addition, when the latch unit 162 finishes the data transfer, the timing generator 13 outputs the start pulse HST again, and the horizontal shift register 161 resumes shifting the data of the 32-bit width from the data latch circuit 15 according to the clock signal HCK.

The level shifter of the level shifter/pixel driver 163 level-shifts to a liquid crystal driving voltage amplitude a signal level of the n items of subframe data associated with the n pixels of one row transferred from the latch unit 162. The pixel driver of the level shifter/pixel driver 163 outputs then items of level-shifted subframe data associated with the n pixels of one row in parallel to the n column data lines d1 to dn.

In one horizontal scan period, the horizontal driver 16 outputs subframe data to pixels of a row selected as a data write target, and shifts the subframe data for the pixels of the row selected as the data write target in next one horizontal scan period in parallel. Furthermore, in a certain horizontal scan period, the n items of subframe data associated with the n pixels of one row are outputted as data signals in parallel and all at once to the n column data lines d1 to dn, respectively.

The n pixels 12 of one row selected according to a row scan signal from the vertical shift register 14 among a plurality of pixels 12 which constitute the image display unit 11 sample the n items of subframe data of one row outputted all at once from the level shifter/pixel driver 163 via the n column data lines d1 to dn, and write the n items of subframe data in the first data holding unit in each pixel 12 described below.

Although the pixel 12 will be described in detail below, inverted data of input data held in a storage unit SM1 is applied to a reflecting electrode PE in the pixel 12. That is, the pixel 12 has a function of inverting the input data supplied from the level shifter/pixel driver 163.

(Specific Configuration of Pixel 12)

Next, the specific configuration of the pixel 12 will be described.

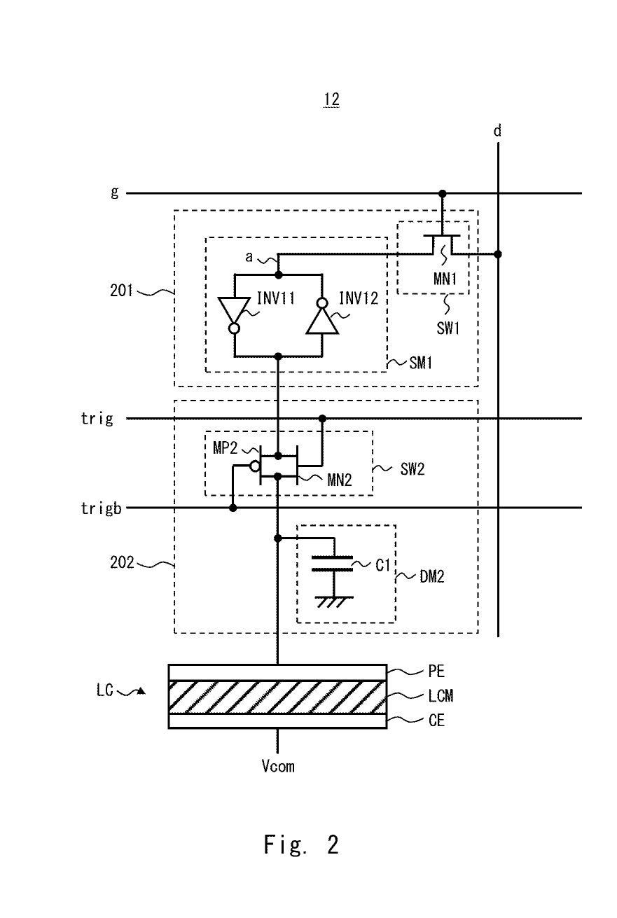

FIG. 2 is a circuit diagram illustrating the specific configuration of the pixel 12.

As illustrated in FIG. 2, the pixel 12 is provided at an intersection portion at which one of the row scan lines g1 to gm (referred to as a row scan line g below) and one of the column data lines d1 to do (referred to as a column data line below) intersect.

The pixel 12 includes an SRAM cell 201, a DRAM cell 202 and a liquid crystal display element LC. The SRAM cell 201 includes a switch SW1 which is a first switch, and the storage unit SM1 which is the first data holding unit. The DRAM cell 202 includes a switch SW2 which is a second switch, and the storage unit DM2 which is the second data holding unit. The liquid crystal display element LC adopts a known structure that liquid crystal LCM is filled and sealed in a space between a reflecting electrode PE which is a pixel electrode disposed apart from and facing the liquid crystal display element LC, and having light reflection characteristics, and a common electrode CE which has light transmittivity.

(Configuration of SRAM Pixel 201)

The switch SW1 includes, for example, an N channel MOS transistor (referred to as an NMOS transistor below) MN1. The NMOS transistor MN1 which constitutes the switch SW1 includes a source which is connected to an input terminal (node a) of the storage unit SM1, a drain which is connected to the column data line d and a gate which is connected to the row scan line g.

The storage unit SM1 is a self-holding memory which includes two inverters INV11 and INV12 whose one output terminal is connected to the other input terminal. More specifically, the input terminal of the inverter INV11 is connected to the output terminal of the inverter INV12 and the source of the NMOS transistor MN1 which constitutes the switch SW1. The input terminal of the inverter INV12 is connected to the switch SW2 and the output terminal of the inverter INV11.

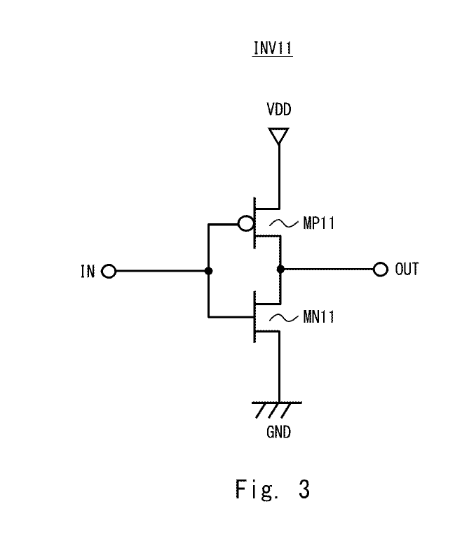

FIG. 3 is a circuit diagram illustrating a specific configuration of the inverter INV11.

As illustrated in FIG. 3, the inverter INV11 is a known CMOS inverter which includes a P channel MOS transistor (referred to as a PMOS transistor below) MP11 and an NMOS transistor MN11 connected in series, and inverts input signals supplied to respective gates and outputs the signals from respective drains. Similarly, the inverter INV12 is a known CMOS inverter which includes a P channel PMOS transistor MP12 and an NMOS transistor MN12 connected in series, and inverts input signals supplied to respective gates and outputs the signals from respective drains.

In this regard, driving capability of the inverters INV11 and INV12 differs. More specifically, the driving capability of the transistors MP11 and MN11 in the inverter INV11 which is an input side seen from the switch SW1 among the inverters INV11 and INV12 which constitute the storage unit SM1 is higher than the driving capability of the transistors MP12 and MN12 in the inverter INV12 which is an output side seen from the switch SW1. Consequently, while data readily propagates from the column data line d to the storage unit SM1 via the switch SW1, data hardly propagates from the storage unit DM2 to the storage unit SM1 via the switch SW2.

Furthermore, the driving capability of the NMOS transistor MN1 which constitutes the switch SW1 is higher than the driving capability of the NMOS transistor MN12 which constitutes the inverter INV12. Consequently, when, for example, data indicating an H level on the column data line d is stored in the storage unit SM1, the current flowing from the column data line d to the input terminal (node a) of the storage unit SM1 via the switch SW1 is higher than the current flowing from the input terminal of the storage unit SM1 to a ground voltage terminal GND via the NMOS transistor MN12, so that it is possible to accurately store the data in the storage unit SM1.

(Configuration of DRAM Cell 202)

The switch SW2 is a known transmission gate which includes an NMOS transistor MN2 and a PMOS transistor MP2 connected in parallel. More specifically, the NMOS transistor MN2 and the PMOS transistor MP2 each include a source which is commonly connected to the output terminal of the storage unit SM1, and a drain which is commonly connected to the input terminal of the storage unit DM2 and the reflecting electrode PE of the liquid crystal display element LC. Furthermore, a gate of the NMOS transistor MN2 is connected to the forward trigger pulse trigger line trig, and a gate of the PMOS transistor MP2 is connected to the inverted trigger pulse trigger line trigb.

When, for example, the forward trigger pulse supplied via the trigger line trig is at the H level (the inverted trigger pulse supplied via the trigger line trigb is at an L level), the switch SW2 enters an on state, and transfers data read from the storage unit SM1 to the storage unit DM2 and the reflecting electrode PE. Furthermore, when the forward trigger pulse supplied via the trigger line trig is at the L level (the inverted trigger pulse supplied via the trigger line trigb is at the H level), the switch SW2 enters an off state, and does not read storage data from the storage unit SM1.

The switch SW2 is the known transmission gate, so that it is possible to transfer the voltage in a wide range from the ground voltage GND to the power supply voltage VDD in the on state. More specifically, when the voltage to be applied from the storage unit SM1 to the sources of the transistors MN2 and MP2 is at a ground voltage GND level (L level), while the source and the drain of the PMOS transistor MP2 do not conduct, the source and the drain of the NMOS transistor MN2 can conduct at a low resistance. On the other hand, when the voltage to be applied from the storage unit SM1 to the sources of the transistors MN2 and MP2 is at a power supply voltage VDD level (H level), while the source and the drain of the NMOS transistor MN2 do not conduct, the source and the drain of the PMOS transistor MP2 can conduct at a low resistance. Consequently, the source and the drain of the transmission gate can conduct at the low resistance, so that the switch SW2 can transfer the voltage in a wide range from the ground voltage GND to the power supply voltage VDD in the on state.

The storage unit DM2 includes a capacitance C1. As the capacitance C1, for example, a MIM (Metal Insulation Metal) capacitance which forms a capacitance between wirings, a Diffusion capacitance which forms a capacitance between a substrate and a polysilicon or a PIP (Poly Insulator Poly) capacitance which forms a capacitance between a two-layer polysilicon can be used.

When the switch SW2 is turned on, data stored in the storage unit SM1 is read, and is transferred to the capacitance C1 in the storage unit DM2 and the reflecting electrode PE via the switch SW2. Consequently, the data stored in the storage unit DM2 is overwritten.

In this regard, when the switch SW2 is turned on, the data held in the capacitance C1 influences on an input gate of the inverter INV12, too, which constitutes the storage unit SM1. However, the driving capability of the inverter INV11 is higher than the driving capability of the inverter INV12, and therefore before the inverter INV12 is influenced by the data of the capacitance C1, the inverter INV11 overwrites the data in the capacitance C1. Consequently, the held data in the capacitance C1 does not unintentionally overwrite the data of the storage unit SM1.

Thus, the liquid crystal display apparatus 10 according to the present embodiment uses the pixels 12 which each include one SRAM cell and one DRAM cell and consequently reduce the number of transistors which constitute each pixel compared to a case where pixels each including two SRAM cells are used, and realize miniaturization of the pixels.

The present embodiment has described a case where the switch SW2 includes the PMOS transistor MP2 and the NMOS transistor MN2, yet is not limited to this. The switch SW2 can be optionally changed to a configuration provided with one of the PMOS transistor MP2 and the NMOS transistor MN2. In this case, only one of the trigger lines trig and trigb is provided.

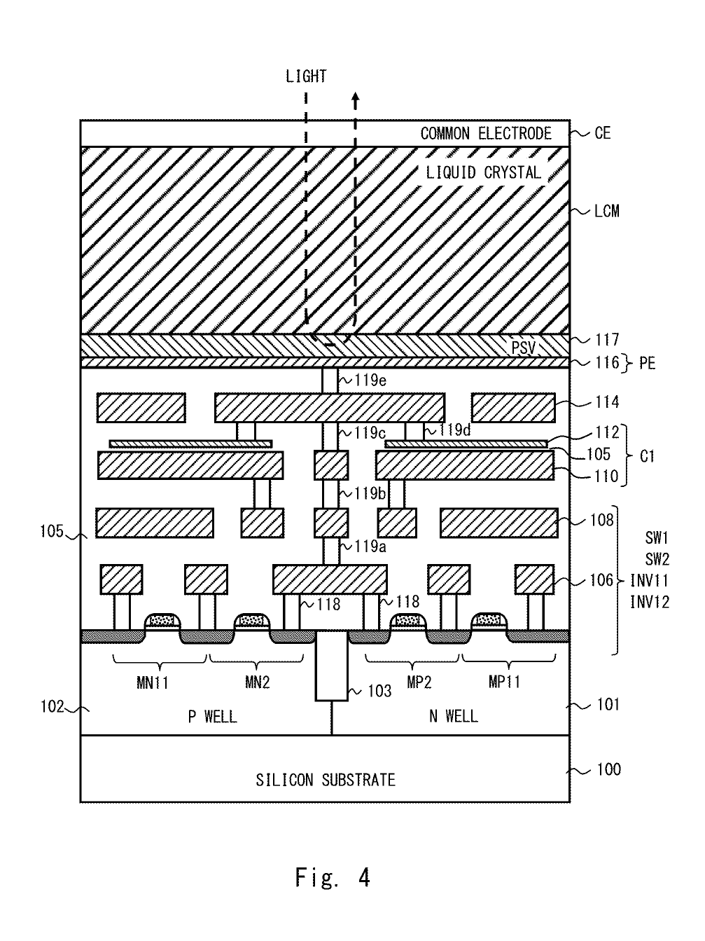

In addition, the liquid crystal display apparatus 10 can not only realize miniaturization of the pixels by reducing the number of transistors which constitute each pixel, but also realize the miniaturization of the pixels by effectively disposing the storage units SM1 and DM2 and the reflecting electrode PE in an element height direction as described below. Details will be described below with reference to FIG. 4.

(Cross-Sectional Structure of Pixel 12)

FIG. 4 is a schematic cross-sectional view illustrating main units of the pixel 12. Furthermore, a case where the capacitance C1 is constituted by the MIM which forms a capacitance between wirings will be described as an example with reference to FIG. 4.

As illustrated in FIG. 4, an N well 101 and a P well 102 are formed on a silicon substrate 100.

The PMOS transistor MP2 of the switch SW2 and the PMOS transistor MP11 of the inverter INV11 are formed on the N well 101. More specifically, a common diffusion layer which is a source of each of the PMOS transistors MP2 and MP11, and two diffusion layers which are the drains are formed on the N well 101, and a polysilicon which is a gate of each of the PMOS transistors MP2 and MP11 is formed with a gate oxide film interposed therebetween on a channel region between the common diffusion layer and the two diffusion layers.

The NMOS transistor MN2 of the switch SW2 and the NMOS transistor MN11 of the inverter INV11 are formed on the P well 102. More specifically, a common diffusion layer which is a source of each of the NMOS transistors MN2 and MN11 and two diffusion layers which are drains are formed on the P well 102, and a polysilicon which is a gate of each of the NMOS transistors MN2 and MN11 is formed with a gate oxide film interposed therebetween on a channel region between the common diffusion layer and the two diffusion layers.

In addition, an element separation oxide film 103 is formed between an activation region (the diffusion layers and the channel region) on the N well and an activation region on the P well.

A first metal 106, a second metal 108, a third metal 110, an MIM electrode 112, a fourth metal 114 and a fifth metal 116 are laminated above the transistors MP2, MP11, MN2 and MN11 with an inter-layer insulation film 105 interposed between the metals.

The fifth metal 116 forms the reflecting electrode PE formed per pixel. Each diffusion layer which forms each drain of the transistors MN2 and MP2 is electrically connected to the fifth metal 116 via a contact 118, the first metal 106, a through-hole 119a, the second metal 108, a through-hole 119b, the third metal 110, a through-hole 119c, the fourth metal 114 and a through-hole 119e. Furthermore, each diffusion layer which forms each drain of the transistors MN2 and MP2 is electrically connected to the MIM electrode 112 via the contact 118, the first metal 106, the through-hole 119a, the second metal 108, the through-hole 119b, the third metal 110, the through-hole 119c, the fourth metal 114 and the through-hole 119d. That is, each source of the transistors MN2 and MP2 which constitute the switch SW2 is electrically connected to the reflecting electrode PE and the MIM electrode 112.

The reflecting electrode PE (fifth metal 116) is disposed apart from and facing the common electrode CE which is a transparent electrode with a passivation film (PSV) 117 which is a protection film formed on an upper surface of the reflecting electrode PE interposed therebetween. The liquid crystal LCM is filled and sealed between the reflecting electrode PE and the common electrode CE. The reflecting electrode PE, the common electrode CE and the liquid crystal LSM between the reflecting electrode PE and the common electrode CE constitute the liquid crystal display element LC.

In this regard, the MIM electrode 112 is formed on the third metal 110 with the inter-layer insulation film 105 interposed therebetween. These MIM electrode 112, third metal 110 and inter-layer insulation film 105 between the MIM electrode 112 and the third metal 110 constitute the capacitance C1. Hence, while the switches SW1 and SW2 and the storage unit SM1 are formed by using the first metal 106 and the second metal 108 which are the first and second layer wirings, and the transistors, the storage unit DM2 is formed by using the third metal 110 and the MIM electrode 112 which are upper layers of the switches SW1 and SW2 and the storage unit SM1. That is, the switches SW1 and SW2 and the storage unit SM1, and the storage unit DM2 are formed in the different layers.

Light from an unillustrated light source transmits through the common electrode CE and the liquid crystal LCM, enters and is reflected by the reflecting electrode PE (fifth metal 116), reversely propagates in the original entrance route, and is emitted through the common electrode CE.

Thus, the liquid crystal display apparatus 10 uses the fifth metal 116 which is a fifth layer wiring as the reflecting electrode PE, the third metal 110 which is the third layer wiring as part of the storage unit DM2, and uses the first metal 106 and the second metal 108 which are the first and second wirings, and the transistors as the storage unit SM1, so that it is possible to effectively dispose the storage unit SM1, the storage unit DM2 and the reflecting electrode PE in the height direction and further miniaturize the pixels. Consequently, each pixel having a pitch equal to or less than 3 μm can be formed by the transistor whose power supply voltage is 3.3 V. By using the pixels having the pitch equal to or less than 3 it is possible to realize a liquid crystal display panel whose diagonal length is 0.55 inches, and which has 4000 pixels in a horizontal direction and 2000 pixels in a vertical direction.

(Operation of Liquid Crystal Display Apparatus 10)

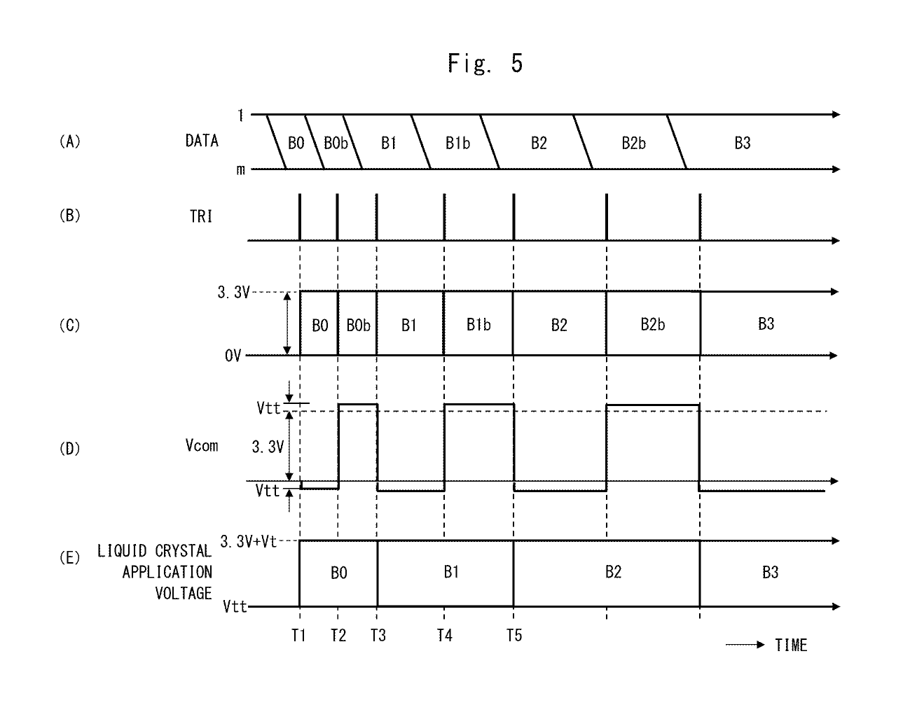

Next, the operation of the liquid crystal display apparatus 10 will be described with reference to FIG. 5.

FIG. 5 is a timing chart illustrating the operation of the liquid crystal display apparatus 10.

As described above, the liquid crystal display apparatus 10 sequentially selects the row scan lines g1 to gm one by one in the 1H unit according to a row scan signal from the vertical shift register 14. Consequently, data is written in a plurality of pixels 12 which constitute the image display unit 11 in n pixel units of one row commonly connected to the selected row scan line. Furthermore, when data is written in all of a plurality of pixels 12 which constitute the image display unit 11, data of all the pixels 12 is then read all at once based on trigger pulses TRI and TRIB (more specifically, data of the storage unit SM1 in all the pixels 12 is transferred all at once to the storage unit DM2 and the reflecting electrode PE).

FIG. 5A illustrates a change in subframe data stored in each pixel 12. In addition, the vertical axis indicates a row number, and the horizontal axis indicates a time. As illustrated in FIG. 5A, boundary lines of subframe data go toward a lower right. This indicates that subframe is written with delay in a pixel of a larger row number. A period from one end to the other end of these boundary lines corresponds to a write period of the subframe data. In addition, B0b, B1b and B2b indicate inverted data of the subframe data of bits B0, B1 and B2, respectively.

FIG. 5B illustrates an output timing (rising timing) of the trigger pulse TRI. In addition, the trigger pulse TRIB indicates a value obtained by logically inverting the trigger pulse TRI at all times, and therefore is omitted. FIG. 5C schematically illustrates bits of subframe data to be applied to the reflecting electrode PE. FIG. 5D illustrates a change in a value of the common electrode voltage Vcom. FIG. 5E illustrates a change in a voltage to be applied to the liquid crystal LCM.

First, the switch SW1 is turned on in the pixel 12 selected according to a row scan signal, and therefore forward subframe data of the bit B0 outputted from the horizontal driver 16 to the column data line d is sampled by the switch SW1 and is written in the storage unit SM1. Similarly, the forward subframe data of the bit B0 is written in the storage units SM1 of all the pixels 12 which constitute the image display unit 11. Subsequently, the trigger pulse TRI of the H level (and the trigger pulse TRIB of the L level) is simultaneously supplied to all the pixels 12 which constitute the image display unit 11 (time t1).

Thus, the switches SW2 of all the pixels 12 are turned on, so that the forward subframe data of the bit B0 stored in the storage units SM1 is transferred all at once to and held by the storage units DM2 via the switches SW2, and the forward subframe data of the bit B0 is applied to the reflecting electrode PE. In addition, as is clear from FIG. 5C, a holding period of the forward subframe data of the bit B0 (an application period of the forward subframe data of the bit B0 to the reflecting electrode PE) in the storage unit DM2 is one subframe period in which the trigger pulse TRI reaches the H level again next time (time T2) after reaching the H level (time t1).

In this regard, when a bit value of subframe data is “1”, i.e., the H level, the power supply voltage VDD (3.3 V in this case) is applied to the reflecting electrode PE. When the bit value is “0”, i.e., the L level, the ground voltage GND (0 V) is applied to the reflecting electrode PE. On the other hand, a free voltage can be applied as the common electrode voltage Vcom to the common electrode CE without being limited to the ground voltage GND and the power supply voltage VDD, and the common electrode voltage Vcom is controlled to switch to a predetermined voltage in synchronization with an input of the forward trigger pulse TRI of the H level. In this example, as illustrated in FIG. 5D, during the subframe period in which the forward subframe data of the bit B0 is applied to the reflecting electrode PE, the common electrode voltage Vcom is set to a voltage which is lower by a threshold voltage Vtt of the liquid crystal than 0 V.

The liquid crystal display element LC displays a tone matching the application voltage of the liquid crystal LCM which is an absolute value of a differential voltage between the application voltage of the reflecting electrode PE and the common electrode voltage Vcom. Hence, as illustrated in FIG. 5E, in the subframe period (times T1 to T2) in which the forward subframe data of the bit B0 is applied to the reflecting electrode PE, the application voltage of the liquid crystal LCM is 3.3 V+Vtt (=3.3 V−(−Vtt)) when the bit value of the subframe data is “1”, and is +Vtt (=0V−(−Vtt)) when the bit value of the subframe data is “0”.

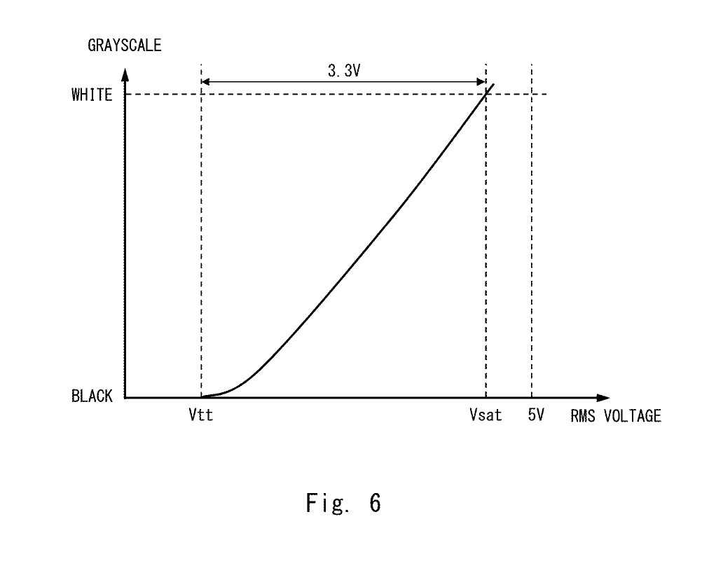

FIG. 6 illustrates a relationship between a liquid crystal application voltage (RMS voltage) and a liquid crystal grayscale value.

In view of FIG. 6, a grayscale value curve is shifted such that a black grayscale value matches the RMS voltage of the threshold voltage Vtt of the liquid crystal and a white grayscale value matches the RMS voltage of a saturation voltage Vsat (=3.3 V+Vtt) of the liquid crystal. It is possible to match the grayscale value with an effective portion of a liquid crystal response curve. Hence, the liquid crystal display element LC displays white when the application voltage of the liquid crystal LCM is (3.3 V+Vtt) as described above, and displays black when the application voltage is +Vtt.

Back to FIG. 5, in the subframe period (times T1 to T2) in which the liquid crystal display element LC displays the forward subframe data of the bit B0, inverted subframe data of the bit B0 starts being sequentially written in the storage units SM1 of all the pixels 12 which constitute the image display unit 11. Furthermore, when the inverted subframe data of the bit B0 is written in the storage units SM1 of all the pixels 12 which constitute the image display unit 11, the trigger pulse TRI of the H level (and the trigger pulse TRIB of the L level) is then simultaneously supplied to all the pixels 12 which constitute the image display unit 11 (time T2).

Thus, the switches SW2 of all the pixels 12 are turned on, and therefore the inverted subframe data of the bit B0 stored in the storage units SM1 is transferred all at once to and held by the storage units DM2 via the switches SW2, and the inverted subframe data of the bit B0 is applied to the reflecting electrode PE. In this regard, as is clear from FIG. 5C, a holding period of the inverted subframe data of the bit B0 (an application period of the inverted subframe data of the bit B0 to the reflecting electrode PE) in the storage unit DM2 is one subframe period in which the trigger pulse TRI reaches the H level again next time (time t3) after reaching the H level (time T2). In this regard, the inverted subframe data of the bit B0 has a relationship of a reverse logical value with the forward subframe data of the bit B0 at all times, and therefore is “0” when the forward subframe data of the bit B0 is “1” and is “1” when the forward subframe data of the bit B0 is “0”.

On the other hand, as illustrated in FIG. 5D, during the subframe period in which the inverted subframe data of the bit B0 is applied to the reflecting electrode PE, the common electrode voltage Vcom is applied to a voltage which is higher by the threshold voltage Vtt of the liquid crystal than 3.3 V. Hence, in the subframe period (times T2 to T3) in which the inverted subframe data of the bit B0 is applied to the reflecting electrode PE, the application voltage of the liquid crystal LCM is −Vtt (=3.3 V−(3.3 V+Vtt)) when the bit value of the subframe data is “1”, and is −3.3 V−Vtt (=0 V−(3.3 V+Vtt)) when the bit value of the subframe data is “0”.

When, for example, the bit value of the forward subframe data of the bit B0 is “1”, the bit value of the inverted subframe data of the bit B0 to be subsequently applied is “0”. In this case, the application voltage of the liquid crystal LCM is −(3.3 V+Vtt), and a potential direction becomes reverse yet the absolute value is the same compared to a case where the forward subframe data of the bit B0 is applied. Hence, even when the inverted subframe data of the bit B0 is applied, the pixel 12 displays white similar to a case where the forward subframe data of the bit B0 is applied. Furthermore, when the bit value of the forward subframe data of the bit B0 is “0”, the bit value of the inverted subframe data of the bit B0 to be subsequently applied is “1”. In this case, the application voltage of the liquid crystal LCM is −Vtt, and the potential direction becomes reverse yet the absolute value is the same compared to a case where the forward subframe data of the bit B0 is applied. Hence, when the inverted subframe data of the bit B0 is applied, too, the pixel 12 displays black similar to a case where the forward subframe data of the bit B0 is applied.

Hence, as illustrated in FIG. 5E, during two subframe periods of the times T1 to T3, the pixel 12 displays the same tone as the bit B0 and the complementary bit B0B of the bit B0, and performs alternating driving of reversing the potential direction of the liquid crystal LCM per subframe, so that it is possible to prevent burn-in of the liquid crystal LCM.

Next, in the subframe period (times T2 to T3) in which the liquid crystal display element LC displays the inverted subframe data of the bit B0, the forward subframe data of the bit B1 starts being sequentially written in the storage units SM1 of all the pixels 12. Furthermore, when the forward subframe data of the bit B1 is written in the storage units SM1 of all the pixels 12 of the image display unit 11, the trigger pulse TRI of the H level (and the trigger pulse TRIB of the L level) is then simultaneously supplied to all the pixels 12 which constitute the image display unit 11 (time T3).

Thus, the switches SW2 of all the pixels 12 are turned on, so that the forward subframe data of the bit B1 stored in the storage units SM1 is transferred all at once to and held by the storage units DM2 via the switches SW2, and the forward subframe data of the bit B1 is applied to the reflecting electrode PE. In addition, as is clear from FIG. 5C, in a holding period of the forward subframe data of the bit B1 (an application period of the forward subframe data of the bit B to the reflecting electrode PE) in the storage unit DM2 is one subframe period in which the trigger pulse TRI reaches the H level again next time (time T4) after reaching the H level (time T3).

On the other hand, as illustrated in FIG. 5D, in the subframe period in which the forward subframe data of the bit B1 is applied to the reflecting electrode PE, the common electrode voltage Vcom is set to a voltage which is lower by the threshold voltage Vtt of the liquid crystal than 0 V. Consequently, as illustrated in FIG. 5E, in the subframe period (times T3 to T4) in which the forward subframe data of the bit B1 is applied to the reflecting electrode PE, the application voltage of the liquid crystal LCM is 3.3 V+Vtt (=3.3 V−(−Vtt)) when the bit value of the subframe data is “1”, and is +Vtt (=0 V−(−Vtt)) when the bit value of the subframe data is “0”.

Next, in the subframe period (times T3 to T4) in which the liquid crystal display element LC displays the forward subframe data of the bit B1, the inverted subframe data of the bit B1 starts being sequentially written in the storage units SM1 of all the pixels 12 which constitute the image display unit 11. Furthermore, when the inverted subframe data of the bit B1 is written in the storage units SM1 of all the pixels 12 which constitute the image display unit 11, the trigger pulse TRI of the H level (and the trigger pulse TRIB of the L level) is then simultaneously supplied to all the pixels 12 which constitute the image display unit 11 (time T4).

Thus, the switches SW2 of all the pixels 12 are turned on, so that the inverted subframe data of the bit B1 stored in the storage units SM1 are transferred all at once to and held by the storage units DM2 via the switches SW2, and the inverted subframe data of the bit B1 is applied to the reflecting electrode PE. In this regard, as is clear from FIG. 5C, in a holding period of the inverted subframe data of the bit B1 (an application period of the inverted subframe data of the bit B1 to the reflecting period PE) in the storage unit DM2 is one subframe period in which the trigger pulse TRI reaches the H level again next time (time T5) after reaching the H level (time T4). In this regard, the inverted subframe data of the bit B1 has a relationship of a reverse logical value with the forward subframe data of the bit B1 at all times.

On the other hand, as illustrated in FIG. 5D, during the subframe period in which the inverted subframe data of the bit B1 is applied to the reflecting electrode PE, the common electrode voltage Vcom is set to a voltage which is higher by the threshold voltage Vtt of the liquid crystal than 3.3 V. Hence, in the subframe period (times T4 to T5) in which the inverted subframe data of the bit B1 is applied to the reflecting electrode PE, the application voltage of the liquid crystal LCM is −Vtt (=3.3 V−(3.3 V+Vtt)) when the bit value of the subframe data is “1”, and is −3.3 V−Vtt (=0 V−(3.3 V+Vtt)) when the bit value of the subframe data is “0”.

Consequently, as illustrated in FIG. 5E, during the two subframe periods of the times T3 to T5, the pixel 12 displays the same tone as the bit B1 and the complementary B1b of the bit B1, and performs alternating driving of reversing the potential direction of the liquid crystal LCM per subframe, so that it is possible to prevent burn-in of the liquid crystal LCM. The same operation is repeatedly performed on the bit B2 and subsequent bits, too.

In this way, the liquid crystal display apparatus 10 displays the tone based on a combination of a plurality of subframes.

In addition, each display period of the bit B0 and the complementary bit B0b is the same first subframe period, and, furthermore, each display period of the bit B1 and the complementary B1b is also the same second subframe period. However, the first subframe period and the second subframe period are not necessarily the same period. In this regard, for example, the second subframe period is set twice as the first subframe period. Furthermore, as illustrated in FIG. 5E, the third subframe period which is each display period of the bit B2 and the complementary bit B2b is set twice as the second subframe period. The same applies to other subframe periods, too. The duration of each subframe period and the number of subframes can be optionally set according to a system specification.

(Specific Configuration of Latch Unit 562 According to Idea Which Does Not Arrive at First Embodiment)

In addition, before the latch unit 162 provided to the horizontal driver 16 will be described in detail, a latch unit 562 studied by the inventors of the invention will be described first.

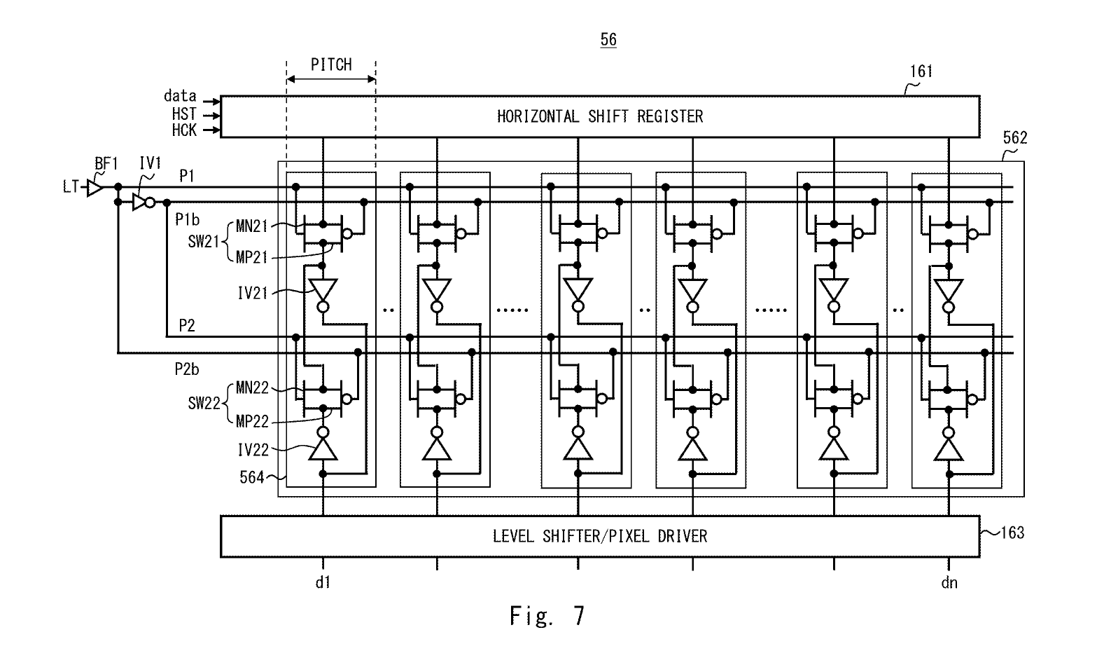

FIG. 7 is a circuit diagram illustrating a specific configuration of the latch unit 562 according to the idea which does not yet arrive at the first embodiment. In addition, FIG. 7 illustrates the horizontal shift register 161 and the level shifter/pixel driver 163 which are peripheral circuits of the latch unit 562.

As illustrated in FIG. 7, the latch unit 562 includes n latch circuits 564 associated with n columns of a plurality of pixels 12 disposed in a matrix pattern. The n latch circuits 564 are disposed facing the n pixels 12, respectively, disposed in the row direction, and have pitches (the widths in the row direction) matching the pitches of the n pixels 12.

In addition, the latch unit 562 receives a supply of pulse signals P1, P1b, P2 and P2b obtained by forwarding or inverting the latch pulse LT from the timing generator 13. More specifically, the latch unit 562 receives a supply of the pulse signals P1 and P2b obtained by forwarding the latch pulse LT by a buffer BF1, and the pulse signals P1b and P2 obtained by inverting the latch pulse LT by an inverter IV1.

A switch SW21 is a known transmission gate which includes an NMOS transistor MN21 and a PMOS transistor MP21 connected in parallel. More specifically, the NMOS transistor MN21 and the PMOS transistor MP21 each include a source which is commonly connected to a corresponding output terminal of the horizontal shift register 161, and a drain which is commonly connected to an input terminal of an inverter IV21. Furthermore, a gate of the NMOS transistor MN21 receives a supply of the pulse signal P1, and a gate of the PMOS transistor MP1 receives a supply of the pulse signal P1b which is an inverted signal of the pulse P1.

An output terminal of the inverter IV21 is connected to an input terminal of an inverter IV22 and a corresponding input terminal of the level shifter/pixel driver 163.

A switch SW22 is a known transmission gate which includes an NMOS transistor MN22 and a PMOS transistor MP22 connected in parallel. More specifically, the NMOS transistor MN22 and the PMOS transistor MP22 each include a source which is commonly connected to an output terminal of the inverter IV22, and a drain which is commonly connected to an input terminal of the inverter IV21. Furthermore, a gate of the NMOS transistor MN22 receives a supply of the pulse signal P2, and a gate of the PMOS transistor MP22 receives a supply of the pulse signal P2b which is an inverted signal of the pulse signal P2.

When, for example, the latch pulse LT is at the L level, the pulse signals P1 and P2b indicate the L level, and the pulse signals P1b and P2 indicate the H level, and therefore the switch SW21 is turned off and the switch SW22 is turned on. On the other hand, when the latch pulse LT is at the H level, the pulse signals P1 and P2b indicate the H level, and the pulse signals P1b and P2 indicate the L level, and therefore the switch SW21 is turned on and the switch SW22 is turned off.

(Operation of Horizontal Driver 56 Including Latch Unit 562)

Next, the operation of the horizontal driver 56 including the latch unit 562 will be described.

For example, the latch pulse LT indicates the L level, first. Thus, the pulse signals P1 and P2b indicate the L level and the pulse signals P1b and P2 indicate the H level, and therefore the switch SW21 is turned off and the switch SW22 is turned on. In this case, when the horizontal shift register 161 is a one-bit serial data processing system, the horizontal shift register 161 starts shifting according to the start pulse HST supplied at an initial stage of the 1H from the timing generator 13, and shifts data of a 32-bit width supplied from the data latch circuit 15 in synchronization with the clock signal HCK.

Subsequently, when the horizontal shift register 161 finishes shifting data corresponding to the same n bits as the number of pixels n of one row of the image display unit 11, the latch pulse LT rises (the L level is switched to the H level). Thus, the pulse signals P1 and P2b rise (the L level is switched to the H level) and the pulse signals P1b and P2 drop (the H level is switched to the L level), and therefore the switch SW21 is turned on and the switch SW22 is turned off. Thus, data corresponding to the n bits (i.e., subframe data associated with the n pixels) outputted in parallel from the horizontal shift register 161 is transferred to the level shifter/pixel driver 163 via the latch unit 562.

In this case, the level shifter of the level shifter/pixel driver 163 level-shifts to a liquid crystal driving voltage amplitude a signal level of n items of subframe data associated with the n pixels of one row transferred from the latch unit 562. The pixel driver of the level shifter/pixel driver 163 outputs then items of level-shifted subframe data associated with the n pixels of one row in parallel to the n column data lines d1 to dn. That is, in a horizontal scan period, the n items of subframe data associated with the n pixels of one row are outputted as data signals in parallel and all at once to the n column data lines d1 to dn, respectively.

Subsequently, the latch pulse LT drops. Thus, the pulse signals P1 and P2b drop and the pulse signals P1b and P2 rise, and therefore the switch SW21 is turned off and the switch SW22 is turned on. Thus, the latch unit 562 is separated from the horizontal shift register 161 yet continues holding the subframe data associated with the n pixels having been supplied from the horizontal shift register 161 immediately before. Consequently, the latch unit 562 can continue outputting the subframe data associated with the n pixels in parallel to the n column data lines d1 to dn.

In addition, during a period in which the latch pulse LT indicates the L level, the horizontal shift register 161 receives a supply of the start pulse HST of a next 1H from the timing generator 13. Thus, the horizontal shift register 161 resumes an operation of shifting the data of the 32-bit width supplied from the data latch circuit 15.

That is, the horizontal driver 56 outputs subframe data to pixels of a row selected as a data write target in one horizontal scan period, and shifts subframe data for the pixels of the row selected as a data write target in a next horizontal scan period in parallel.

In this regard, according to a configuration of the latch unit 562, the n items of subframe data for the n pixels 12 are outputted in parallel and all at once to the n column data lines d1 to dn in synchronization with the rise of the latch pulse LT. Thus, the liquid crystal display apparatus on which the latch unit 562 is mounted instantaneously increases the current flowing from a power supply voltage terminal to a ground voltage terminal (i.e., a peak consumption current increases), and therefore has a problem that the IR drop phenomenon that the power supply voltage VDD lowers and the ground voltage GND rises occurs. As a result, the liquid crystal display apparatus on which the latch unit 562 is mounted is likely to cause, for example, an erroneous operation and image quality deterioration.

Hence, the latch unit 162 and the liquid crystal display apparatus 10 on which the latch unit 162 is mounted have been found to prevent the occurrence of the IR drop by suppressing the peak consumption current.

(Specific Configuration of Latch Unit 162 According to First Embodiment)

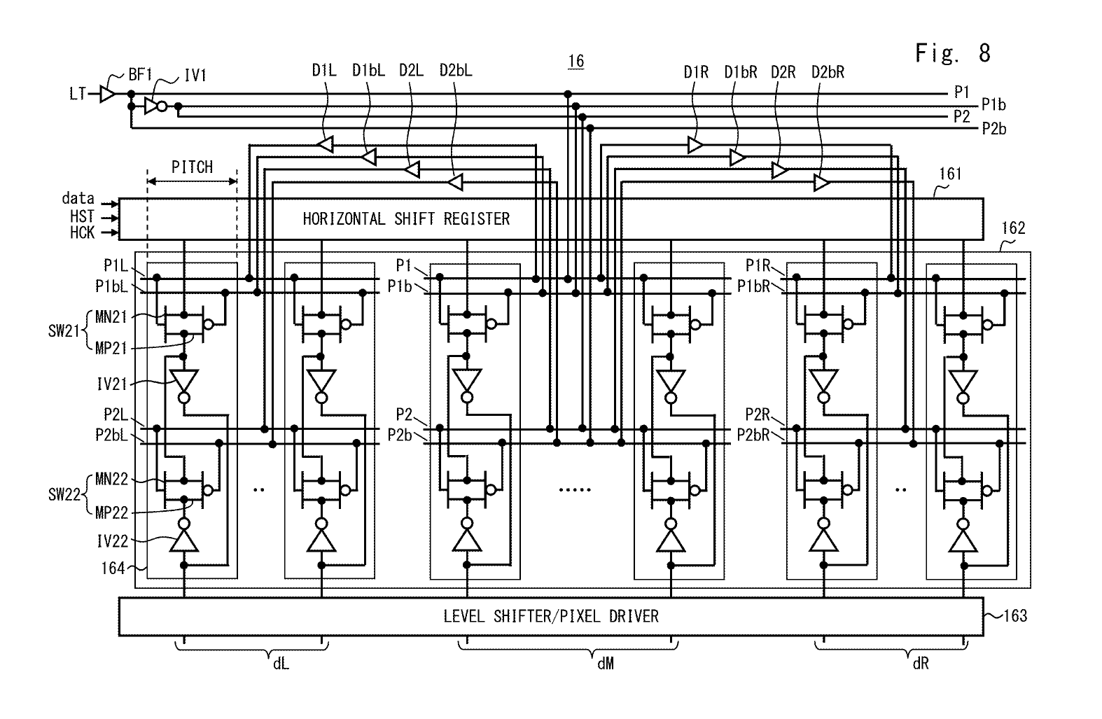

FIG. 8 is a circuit diagram illustrating the specific configuration example of the latch unit 162 according to the first embodiment. In addition, FIG. 8 illustrates the horizontal shift register 161 and the level shifter/pixel driver 163 which are the peripheral circuits of the latch unit 162, too.

As illustrated in FIG. 8, the latch unit 162 includes n latch circuits 164 provided in association with n columns of a plurality of pixels 12 disposed in the matrix pattern. The n latch circuits 164 are disposed facing the n pixels 12, respectively, disposed in the row direction, and have pitches (the widths in the row direction) matching the pitches of the n pixels 12.

Furthermore, the latch unit 162 includes delay buffers D1L, D1bL, D2L and D2bL and delay buffers D1R, D1bR, D2R and D2bR. These delay buffers play a role of timing adjustment circuits which adjust supply timings of subframe data to the respective n pixels 12 provided in each row of a plurality of pixels 12. Details will be described below.

In this regard, then latch circuits 164 are classified into a plurality of latch circuit groups. In the present embodiment, the n latch circuits 164 are classified into the n/3 latch circuits 164 (latch circuit group 1642) disposed at the center, n/3 latch circuits 164 (latch circuit group 1641) disposed on a row direction negative side (the left side in the drawings) of the latch circuit group 1642, and the n/3 latch circuits 164 (latch circuit group 1643) disposed on a row direction positive side (the right side in the drawings) of the latch circuit groups 1642.

The latch circuit group 1642 provided at the center of the latch unit 162 receives a supply of the pulse signals P1, P1b, P2 and P2b obtained by forwarding or inverting the latch pulse LT from the timing generator 13. More specifically, the latch circuit group 1642 receives a supply of the pulse signals P1 and P2b obtained by forwarding the latch pulse LT by the buffer BF1, and receives a supply of the pulse signals P1b and P2 obtained by inverting the latch pulse LT by the inverter IV1.

Furthermore, the latch circuit group 1641 provided in a left region of the latch unit 162 receives a supply of pulse signals P1L, P1bL, P2L and P2bL obtained by delaying the pulse signals P1, P1b, P2 and P2b by using the delay buffers D1L, D1bL, D2L and D2bL, respectively.

Furthermore, the latch circuit group 1643 provided in a right region of the latch unit 162 receives a supply of pulse signals P1R, P1bR, P2R and P2bR obtained by delaying the pulse signals P1, P1b, P2 and P2b by using the delay buffers D1R, D1bR, D2R and D2bR, respectively.

In each latch circuit 164 of the latch circuit group 1642 provided at the center of the latch unit 162, the switch SW21 is a known transmission gate which includes the NMOS transistor MN21 and the PMOS transistor MP21 connected in parallel. More specifically, the NMOS transistors MN21 and the PMOS transistor MP21 each include a source which is commonly connected to the corresponding output terminal of the horizontal shift register 161, and a drain which is commonly connected to the input terminal of the inverter IV21. Furthermore, the gate of the NMOS transistor MN21 receives a supply of the pulse signal P1, and the gate of the PMOS transistor MP21 receives a supply of the pulse signal P1b which is an inverted signal of the pulse signal P1. The output terminal of the inverter IV21 is connected to the input terminal of the inverter IV22 and the corresponding input terminal of the level shifter/pixel driver 163.

Furthermore, in each latch circuit 164 of the latch circuit group 1642, the switch SW22 is a known transmission gate which includes the NMOS transistor MN22 and the PMOS transistor MP22 connected in parallel. More specifically, the NMOS transistor MN22 and the PMOS transistor MP22 each include the source which is commonly connected to the output terminal of the inverter IV22, and the drain which is commonly connected to the input terminal of the inverter IV21. Furthermore, the gate of the NMOS transistor MN22 receives a supply of the pulse signal P2, and the gate of the PMOS transistor MP22 receives a supply of the pulse signal P2b which is an inverted signal of the pulse signal P2.

When, for example, the latch pulse LT is at the L level, the pulse signals P1 and P2b indicate the L level, and the pulse signals P1b and P2 indicate the H level. Thus, in each latch circuit 164 of the latch circuit group 1642, the switch SW21 is turned off, and the switch SW22 is turned on. On the other hand, when the latch pulse LT is at the H level, the pulse signals P1 and P2b indicate the H level, and the pulse signals P1b and P2 indicate the L level. Thus, in each latch circuit 164 of the latch circuit group 1642, the switch SW21 is turned on, and the switch SW22 is turned off.

In each latch circuit 164 of the latch circuit group 1641 provided in the left region of the latch unit 162, the gate of the NMOS transistor MN21 receives a supply of the pulse signal P1L, and the gate of the PMOS transistor MP21 receives a supply of the pulse signal P1bL which is an inverted signal of the pulse signal P1L. Furthermore, the gate of the NMOS transistor MN22 receives a supply of the pulse P2L, and the gate of the PMOS transistor MP22 receives a supply of the pulse signal P2bL which is an inverted signal of the pulse signal P2L. The other configuration of each latch circuit 164 of the latch circuit group 1641 is the same as the configuration of each latch circuit 164 of the latch circuit group 1642, and therefore description thereof will be described.

When, for example, the latch pulse LT indicates the L level, after the pulse signals P1 and P2b indicate the L level, the pulse signals P1b and P2 indicate the H level and then a predetermined delay time passes, the pulse signals P1L and P2bL indicate the L level, and the pulse signals P1bL and P2L indicate the H level. Thus, in each latch circuit 164 of the latch circuit group 1641, the switch SW21 is turned off, and the switch SW22 is turned on. On the other hand, when the latch pulse LT indicates the H level, after the pulse signals P1 and P2b indicate the H level, the pulse signals P1b and P2 indicate the L level and then a predetermined delay time passes, the pulse signals P1L and P2bL indicate the H level, and the pulse signals P1bL and P2L indicate the L level. Thus, in each latch circuit 164 of the latch circuit group 1641, the switch SW21 is turned on, and the switch SW22 is turned off.

In each latch circuit 164 of the latch circuit group 1643 provided in the right region of the latch unit 162, the gate of the NMOS transistor MN21 receives a supply of the pulse signal P1R, and the gate of the PMOS transistor MP21 receives a supply of the pulse signal P1bR which is an inverted signal of the pulse signal P1R. Furthermore, the gate of the NMOS transistor MN22 receives a supply of the pulse signal P2R, and the gate of the PMOS transistor MP22 receives a supply of the pulse signal P2bR which is an inverted signal of the pulse signal P2R. The other configuration of each latch circuit 164 of the latch circuit group 1643 is the same as the configuration of each latch circuit 164 of the latch circuit group 1642, and therefore description thereof will be omitted.

When, for example, the latch pulse LT indicates the L level, after the pulse signals P1 and P2b indicate the L level, the pulse signals L1b and P2 indicate the H level and then a predetermined delay time passes, the pulse signals P1R and P2bR indicate the L level, and the pulse signals P1bR and P2R indicate the H level. Thus, in each latch circuit 164 of the latch circuit group 1643, the switch SW21 is turned off, and the switch SW22 is turned on. On the other hand, when the latch pulse LT indicates the H level, after the pulse signals P1 and P2b indicate the H level, the pulse signals P1b and P2 indicate the L level and then a predetermined delay time passes, the pulse signals P1R and P2bR indicate the H level, and the pulse signals P1bR and P2R indicate the L level. Thus, in each latch circuit 164 of the latch circuit group 1643, the switch SW21 is turned on, and the switch SW22 is turned off.

In addition, signal lines in which the pulse signals P1, P1b, P2 and P2b propagate are wired in a wiring layer (e.g., a wiring layer of an upper layer) different from the wiring layer which mainly constitutes the latch circuit 164. Similarly, signal lines in which the pulse signals P1L, P1bL, P2L and P2bL propagate and signal lines in which the pulse signals P1R, P1bR, P2R and P2bR propagate are partially disposed in a wiring layer (e.g., a wiring layer of the upper layer) different from the wiring layer which mainly constitutes the latch circuit 164. Furthermore, the delay buffers D1L, D1bL, D2L and D2bL and the delay buffers D1R, D1bR, D2R and D2bR are each formed in a region (e.g., an upper side in FIG. 8) different from a region which constitutes the latch circuit 164. Consequently, the n latch circuits 164 can be disposed facing the n pixels 12 disposed in the row direction without an influence of the delay buffers and without disturbing pitches. Consequently, the liquid crystal display apparatus 10 can uniformly display an entire image displayed on the image display unit 11 without unevenness. On the other hand, the delay buffers are disposed in the region different from that of the latch circuits 164, so that it is possible to change the sizes and the number of stages of the latch circuits 164 with a high degree of freedom.

(Operation of Horizontal Driver 16 Including Latch Unit 162)

Next, the operation of the horizontal driver 16 including the latch unit 162 will be described.

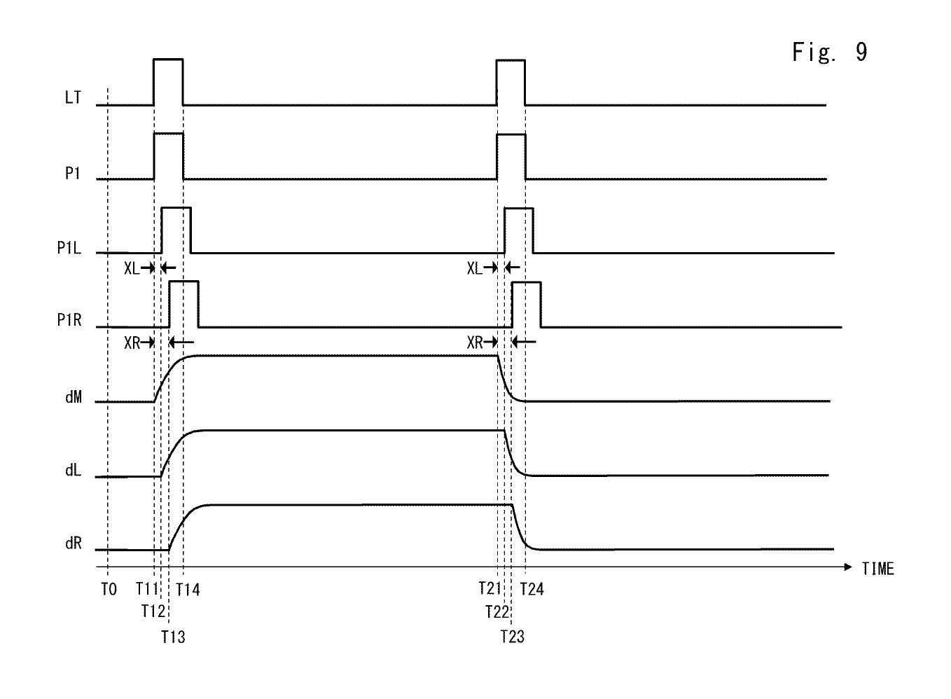

FIG. 9 is a timing chart illustrating the operation of the latch unit 162. In addition, FIG. 9 illustrates an example of a case where “1” is written in the n pixels 12 of the first row, and “0” is written in the n pixels 12 of the second row.

First, the latch pulse LT indicates the L level in an initial state (time T0). Thus, the pulse signals P1 and P2b indicate the L level and the pulse signals P1b and P2 indicate the H level, and therefore, in each latch circuit 164 of the latch circuit group 1642, the switch SW21 is turned off, and the switch SW22 is turned on. Furthermore, the pulse signals P1L and P2bL indicate the L level and the pulse signals P1bL and P2L indicate the H level, and therefore, in each latch circuit 164 of the latch circuit group 1641, the switch SW21 is turned off, and the switch SW22 is turned on. Furthermore, the pulse signals P1R and P2bR indicate the L level and the pulse signals P1bR and P2R indicate the H level, and therefore, in each latch circuit 164 of the latch circuit group 1643, the switch SW21 is turned off, and the switch SW22 is turned on.

Subsequently, when the latch pulse LT rises (time T11), the pulse signals P1 and P2b rise, and the pulse signals P1b and P2 drop following the rise of the latch pulse LT (time T11). Thus, in each latch circuit 164 of the latch circuit group 1642, the switch SW21 is turned on, and the switch SW22 is turned off. Thus, n/3 items of subframe associated with each latch circuit 164 of the latch circuit group 1642 among the subframe data associated with the n pixels of the first row outputted from the horizontal shift register 161 are transferred to the level shifter/pixel driver 163.

In this case, the level shifter of the level shifter/pixel driver 163 level-shifts to the liquid crystal driving voltage amplitude the n/3 items of subframe data transferred from the latch unit 162. The pixel driver of the level shifter/pixel driver 163 outputs the n/3 items of level-shifted subframe data in parallel to the n/3 column data lines d (column data line dM) provided in association with each latch circuit 164 of the latch circuit group 1642. Thus, a voltage level of each column data line d of the column data line group dM is switched from the L level to the H level (time T11).

Next, after the pulse signals P1 and P2b rise, the pulse signals P1b and P2 drop and then a predetermined delay time passes, the pulse signals P1L and P2bL rise, and the pulse signals P1bL and P2L drop (time T12). Thus, in each latch circuit 164 of the latch circuit group 1641, the switch SW21 is turned on, and the switch SW22 is turned on. Thus, the n/3 items of subframe data associated with each latch circuit 164 of the latch circuit group 1641 among the subframe data associated with the n pixels of the first row outputted from the horizontal shift register 161 are transferred to the level shifter/pixel driver 163.

In this case, the level shifter of the level shifter/pixel driver 163 level-shifts to the liquid crystal driving voltage amplitude the n/3 items of subframe data transferred from the latch unit 162. The pixel driver of the level shifter/pixel driver 163 outputs the n/3 items of level-shifted subframe data in parallel to the n/3 column data lines d (column data line group dL) provided in association with each latch circuit 164 of the latch circuit group 1641. Thus, the voltage level of each column data line d of the column data line group dL switches from the L level to the H level (time T12).

Next, after the pulse signals P1 and P2b rise, the pulse signals P1b and P2 drop and then the predetermined delay time passes, the pulse signals P1R and P2bR rise, and the pulse signals P1bR and P2R drop (time T13). FIG. 9 illustrates a case where the delay buffers D1R, D1bR, D2R and D2bR in FIG. 8 are delayed compared to the delay buffers D1L, D1bL, D2L and D2bL. This is because left and right delay times are differed to reduce the number of circuits which operate at a time and thereby reduce a peak consumption current. Naturally, the delay buffers D1R, D1bR, D2R and D2bR can be also set to the same delay time as that of the delay buffers D1L, D1bL, D2L and D2bL. Thus, in each latch circuit 164 of the latch circuit group 1643, the switch SW21 is turned on, and the switch SW22 is turned off. Thus, the n/3 items of subframe data associated with each latch circuit 164 of the latch circuit group 1643 among the subframe data associated with the n pixels of the first row outputted from the horizontal shift register 161 are transferred to the level shifter/pixel driver 163.

In this case, the level shifter of the level shifter/pixel driver 163 level-shifts to the liquid crystal driving voltage amplitude the n/3 items of subframe data transferred from the latch unit 162. The pixel driver of the level shifter/pixel driver 163 outputs the n/3 items of level-shifted subframe data in parallel to the n/3 column data lines d (column data line group dR) provided in association with each latch circuit 164 of the latch circuit group 1643. Thus, the voltage level of each column data line d of the column data line group dR switches from the L level to the H level (time T13).

In addition, each column data line d additionally includes a parasitic capacitance of a drain electrode of the switch SW1 provided to each pixel 12 of m rows, and a wiring capacitance of the column data line itself. Hence, the voltage level of each column data line d moderately rises (times T11, T12 and T13). Subsequently, the latch pulse LT drops (time T14). Thus, the latch unit 162 is separated from the horizontal shift register 161, yet continues holding the subframe data associated with the n pixels having been supplied from the horizontal shift register 161 immediately before. Consequently, the latch unit 162 can continue outputting the subframe data associated with the n pixels in parallel to then column data lines d1 to dn. As a result, the voltage levels of the n column data lines d1 to dn are maintained at the H level.

Subsequently, when the latch pulse LT rises again (time T21), the pulse signals P1 and P2b rise, and the pulse signals P1b and P2 drop following the rise of the latch pulse LT (time T21). Thus, in each latch circuit 164 of the latch circuit group 1642, the switch SW21 is turned on, and the switch SW22 is turned off. Thus, the n/3 items of subframe data associated with each latch circuit 164 of the latch circuit group 1642 among the subframe data associated with the n pixels of the second row outputted from the horizontal shift register 161 are transferred to the level shifter/pixel driver 163.

In this case, the level shifter of the level shifter/pixel driver 163 level-shifts to the liquid crystal driving voltage amplitude the n/3 items of subframe data transferred from the latch unit 162. The pixel driver of the level shifter/pixel driver 163 outputs the n/3 items of level-shifted subframe data in parallel to the n/3 column data lines d (column line group dM) provided in association with each latch circuit 164 of the latch circuit group 1642. Thus, the voltage level of each column data line d of the column data line group dM switches from the H level to the L level (time T21).

Next, after the pulse signals P1 and P2b rise, the pulse signals P1b and P2 drop and then the predetermined delay time passes, the pulse signals P1L and P2bL rise, and the pulse signals P1bL and P2L drop (time T22). Thus, in each latch circuit 164 of the latch circuit group 1641, the switch SW21 is turned on, and the switch SW22 is turned off. Thus, the n/3 items of subframe data associated with each latch circuit 164 of the latch circuit group 1641 among the subframe data associated with the n pixels of the second row outputted from the horizontal shift register 161 are transferred to the level shifter/pixel driver 163.

In this case, the level shifter of the level shifter/pixel driver 163 level-shifts to the liquid crystal driving voltage amplitude the n/3 items of subframe data transferred from the latch unit 162. The pixel driver of the level shifter/pixel driver 163 outputs the n/3 items of level-shifted subframe data in parallel to the n/3 column data lines d (column data line group dL) provided in association with each latch circuit 164 of the latch circuit group 1641. Thus, the voltage level of each column data line d of the column data line group dL switches from the H level to the L level (time T22).

Next, after the pulse signals P1 and P2b rise, the pulse signals P1b and P2 drop and then the predetermined delay time passes, the pulse signals P1R and P2bR rise, and the pulse signals P1bR and P2R drop (time T23). Thus, in each latch circuit 164 of the latch circuit group 1643, the switch SW21 is turned on, and the switch SW22 is turned off. Thus, the n/3 items of subframe data associated with each latch circuit 164 of the latch circuit group 1643 among the subframe data associated with the n pixels of the second row outputted from the horizontal shift register 161 are transferred to the level shifter/pixel driver 163.

In this case, the level shifter of the level shifter/pixel driver 163 level-shifts to the liquid crystal driving voltage amplitude the n/3 items of subframe data transferred from the latch unit 162. The pixel driver of the level shifter/pixel driver 163 outputs the n/3 items of level-shifted subframe data in parallel to the n/3 column data lines d (column data line group dR) provided in association with each latch circuit 164 of the latch circuit 1643. Thus, the voltage level of each column data line d of the column data line group dR switches from the H level to the L level (time T23).

In addition, each column data line d additionally includes a parasitic capacitance of the drain electrode of the switch SW1 provided to each pixel 12 of the m rows, and a wiring capacitance of the column data line itself. Hence, the voltage level of each column data line d moderately rises (times T21, T22 and T23).

Subsequently, the latch pulse LT drops (time T24). Thus, the latch unit 162 is separated from the horizontal shift register 161, yet continues holding the subframe data associated with the n pixels having been supplied from the horizontal shift register 161 immediately before. Consequently, the latch unit 162 can continue outputting the subframe data associated with the n pixels in parallel to then column data lines d1 to dn. As a result, the voltage levels of the n column data lines d1 to dn are maintained at the L level.

This operation is repeatedly performed on the pixels 12 in the third row to the mth row to write data of one screen of the image display unit 11 finally.

In addition, a delay time XL from the time T11 to the time T12, and the delay time XL from the time T21 to the time T22 can be adjusted by changing the sizes and the number of stages of the delay buffers D1L, D1bL, D2L and D2bL. A delay time XR from the time T11 to the time T13, and the delay time XR from the time T21 to the time T23 can be adjusted by changing the sizes and the number of stages of the delay buffers D1R, D1bR, D2R and D2bR. The configuration where the delay buffers are used to adjust the delay times XL and XR is not a complex circuit configuration compared to the configuration where the delay times XL and XR are adjusted in synchronization with an operation clock, and can adjust the delay times XL and XR more accurately than a cycle of the operation clock.

Thus, the liquid crystal display apparatus according to the present embodiment includes the timing adjustment circuits which adjust supply timings of n items of subframe data associated with the n pixels 12 provided in each row. The timing adjustment circuit is, for example, a delay buffer, and differs the supply timing of subframe data for part of column data lines among the n column data lines provided in association with the n pixels 12 provided in each row, and a timing of supply of subframe data for the other part of column data lines. Consequently, the liquid crystal display apparatus according to the present embodiment can suppress a peak consumption current and prevent the occurrence of the IR drop. As a result, for example, the liquid crystal display apparatus according to the present embodiment can prevent an erroneous operation and prevent image quality deterioration.

Furthermore, in the present embodiment, the delay buffers are disposed in the region different from that of the n latch circuits 164. Consequently, the n latch circuits 164 can be disposed facing the n pixels 12 disposed in the row direction without an influence of the delay buffers and without disturbing the pitches. Consequently, the liquid crystal display apparatus 10 according to the present embodiment can uniformly display an entire image displayed on the image display unit 11 without unevenness.

On the other hand, the delay buffers are disposed in the region different from that of the n latch circuits 164, so that it is possible to change the sizes and the number of stages of the n latch circuits 164 with a high degree of freedom. In this regard, multiple delay buffers are disposed in advance, and only a necessary number of delay buffers are used to constitute the timing adjustment circuits, and, when, for example, a failure occurs subsequently, it is possible to reconfigure the timing adjustment circuits by using delay buffers instead. Alternatively, when timing adjustment is unnecessary, it is also possible not to configure the timing adjustment circuits by using the delay buffers.

The present embodiment has described the example of the case where the n latch circuits 164 are classified into the three latch circuit groups, and the supply timings of subframe data from the three latch circuit groups are differed from each other, yet is not limited to this. It is possible to optionally change the configuration to a configuration where the n latch circuits 164 are classified into an arbitrary number of latch circuit groups which is two or more, and the supply timings of the subframe data from these latch circuit groups are differed from each other.

When, for example, the number of latch circuits which constitute one latch circuit group is made smaller and the number of latch circuit groups which is a timing control unit is made larger, it is possible to more effectively suppress a peak consumption current. On the other hand, when the number of latch circuits which constitute one circuit group is made larger and the number of latch circuit groups which is the timing control unit is made smaller, it is possible to suppress an increase in delay times of the delay buffers, so that it is possible to easily adjust an operation time per 1H of the horizontal driver 16 within an allowable time. In addition, if the operation time per 1H of the horizontal driver 16 cannot be adjusted within the allowable time for a wafer at a testing stage, it is possible to adjust the operation time per 1H of the horizontal driver 16 within an allowable range by changing the sizes and the number of stages of delay buffers or changing a wiring pattern.

Furthermore, the present embodiment has described the example of the case where the number of latch circuits which constitute each of the latch circuit groups 1641 to 1643 is the same, yet is not limited to this. The number of latch circuits which constitute each of the latch circuit groups 1641 to 1643 may differ.

According to the present embodiment, it is possible to provide a liquid crystal display apparatus which can suppress an IR drop by suppressing a peak consumption current.

The exemplary embodiment is suitably applicable to a liquid crystal display apparatus which is mounted on a projector.

What is claimed is:

1. A liquid crystal display apparatus comprising:
a plurality of pixels configured to display an image of a tone level obtained by combining a plurality of items of one-bit subframe data per frame, and provided in a matrix pattern;
n latch circuits configured to supply the subframe data to each of n pixels in a row selected as a data write target among the plurality of pixels; and
a timing adjustment circuit configured to adjust a timing of supply of each of the subframe data from then latch circuits to the n pixels, wherein
the timing adjustment circuit comprises a plurality of inverters, and differs a timing of supply of subframe data to an associated pixel from a first latch circuit group that is a first part of the n latch circuits from a timing of supply of subframe data to an associated pixel from a second latch circuit group that is a second part of the n latch circuits by using delays of the plurality of inverters so that these timings are delayed in two different row directions.

2. The liquid crystal display apparatus according to claim 1, wherein the timing adjustment circuit is formed in a region different from a region in which the n latch circuits are disposed.
